(19) United States
(12) Patent Application Publication
(10) Pub. No.: US 2008/0301436 A1
(43) Pub. Date: Dec. 4, 2008

(54) METHOD AND APPARATUS FOR PERFORMING AUTHENTICATION BETWEEN CLIENTS USING SESSION KEY SHARED WITH SERVER

(75) Inventors: Jun YAO, Suwon-si (KR); Choong-hoon LEE, Seoul (KR); Yong-kuk YOU, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/947,211

(22) Filed: Nov. 29, 2007

(30) Foreign Application Priority Data
Jun. 1, 2007 (KR) 10-2007-0054002

(51) Int. Cl. H04L 9/32

(52) U.S. Cl. 713/155

(57) ABSTRACT

Provided is a method and apparatus for performing authentication between clients that complete authentication with a server. The method includes receiving first authentication information generated using the second session key from the server; receiving second authentication information generated using the second session key from the second client; and determining whether the authentication with the second client is successful using the first authentication information and the second authentication information.

### CROSS-REFERENCE TO RELATED PATENT APPLICATION

This application claims priority from Korean Patent Application No. 10-2007-0054002, filed on Jun. 1, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relates to an authentication method, and more particularly, to performing authentication between a plurality of clients that complete authentication with a server.

2. Description of the Related Art

With rapid increases in the spread and consumption of digital contents, establishing a relationship between rights of a content owner, a service provider, and a content consumer is required and digital right management (DRM) technology has been developed to regulate unrestricted content copy and consumption.

For example, content that should be used only between two entities has to be transmitted and received between the two entities after being encrypted using a domain key. In order to share the domain key, the two entities have to first authenticate each other.

FIG. 1 is a view for explaining a related art authentication method, in which two entities X and Y authenticate each other.

In operation 110, the entity X transmits a random number R1 to the entity Y.

In operation 120, the entity Y encrypts the random number R1 using its private key.

In operation 130, the entity Y transmits data E(R1), which is obtained by encrypting the random number R1 using its private key, and its certificate to the entity X. The certificate of the entity Y includes a public key of the entity Y.

In operation 140, the entity X decrypts the data E(R1) using the public key of the entity Y, which is included in the certificate of the entity Y. If the entity X obtains R1 as a result of decryption using the public key of the entity Y, it can trust the entity Y. This is because R1 has been generated at random by the entity X and decryption of E(R1) using the public key of the entity Y means that E(R1) has been encrypted by the entity Y.

In operations following operation 150, the entity Y verifies the reliability of the entity X.

In operation 150, the entity Y transmits a random number R2 to the entity X.

In operation 160, the entity X encrypts the random number R2 using its private key, thereby generating data E(R2).

In operation 170, the entity X transmits the data E(R2) and its certificate to the entity Y. The certificate of the entity X includes a public key of the entity X.

In operation 180, the entity Y decrypts the data E(R2) using the public key of the entity X, which is included in the certificate of the entity X. If the entity Y obtains R2 as a result of decryption using the public key of the entity X, the entity Y can trust the entity X. This is because R2 has been generated at random by the entity Y and decryption of E(R2) using the public key of the entity X means that E(R2) has been encrypted by the entity X.

As such, the related art authentication method requires encryption using a private key and decryption using a public key. For the encryption and decryption, a large amount of computation is required, increasing the resources and time required for authentication.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method for performing authentication between clients that complete authentication with a server and thus share their session keys with the server using the session keys.

According to an aspect of the present invention, there is provided a method of performing authentication in which a first client sharing a first session key with a server performs authentication with a second client sharing a second session key with the server, the method comprising receiving first authentication information generated using the second session key from the server, receiving second authentication information generated using the second session key from the second client, and determining whether the authentication with the second client is successful using the first authentication information and the second authentication information.

The method may further comprise generating a random number and transmitting the generated random number to the second client, in which the first authentication information may be a hash value with respect to the second session key and the second authentication information may be a hash value with respect to both the random number and the first authentication information, and the determination may include calculating the hash value with respect to both the random number and the first authentication information, comparing the calculated hash value with the received second authentication information, and determining that the authentication with the second client is successful if the calculated hash value is equal to the received second authentication information.

The method may further comprise receiving a random number generated by the second client from the second client, generating third authentication information that is a hash value with respect to both the received random number and the hash value with respect to the first session key, and transmitting the generated third authentication information to the second client.

The reception of the first authentication information may comprise receiving data obtained by encrypting the first authentication information with the first session key and decrypting the received data.

The server may be a digital right management (DRM) server, the first client is a DRM client, and the second client may be a host device in which the DRM client may be installed.

According to another aspect of the present invention, there is provided a computer-readable recording medium having recorded thereon a program for executing the method of performing authentication.

According to another aspect of the present invention, there is provided an apparatus for performing authentication in which a first client sharing a first session key with a server performs authentication with a second client sharing a second session key with the server, the apparatus comprising a communication unit and a determination unit. The communication unit receives first authentication information generated using the second session key from the server and receives second authentication information generated using the second session key from the second client. The determination unit determines whether the authentication with the second client is successful using the first authentication information and the second authentication information.

The apparatus may further comprise a random number generation unit generating a random number, in which the communication unit may transmit the generated random number to the second client, the first authentication information may be a hash value with respect to the second session key and the second authentication information may be a hash value with respect to both the random number and the first authentication information, and the determination unit may calculate the hash value with respect to both the random number and the first authentication information, compare the calculated hash value with the received second authentication information, and determine that the authentication with the second client is successful if the calculated hash value is equal to the received second authentication information.

The communication unit may receive a random number generated by the second client from the second client and transmit third authentication information that is a hash value with respect to both the received random number and the hash value with respect to the first session key to the second client, and the determination unit may generate the third authentication information.

The apparatus may further comprise a decryption unit decrypting data encrypted with the first session key, in which the communication unit may receive the first authentication information in a state encrypted with the first session key.

The server may be a digital right management (DRM) server, the first client is a DRM client, and the second client may be a host device in which the DRM client may be installed.

### BRIEF DESCRIPTION OF THE DRAWINGS

The above and other aspects of the present invention will become more apparent by describing in detail an exemplary embodiment thereof with reference to the attached drawings in which:

FIG. 1 is a view for explaining a related art authentication method;

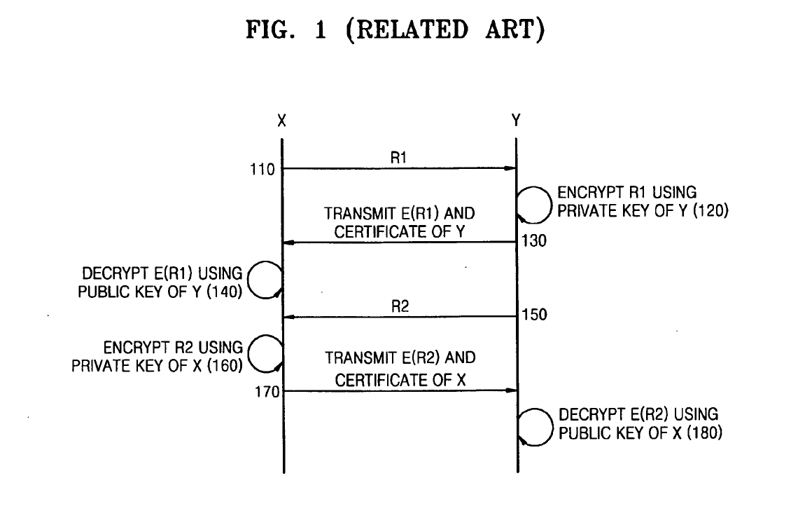

FIG. 2 is a view for explaining an environment to which an exemplary embodiment of the present invention is applied;

FIG. 3 is a flowchart of a process in which a first client authenticates a second client according to an exemplary embodiment of the present invention;

FIG. 4 is a flowchart of a process in which the first client transmits authentication information to the second client according to an exemplary embodiment of the present invention;

FIG. 5 is a block diagram of an apparatus for performing authentication using a session key according to an exemplary embodiment of the present invention;

FIG. 6 is a view for explaining a method of performing authentication using a session key according to an exemplary embodiment of the present invention; and

FIG. 7 is a view for explaining a case where an exemplary embodiment of the present invention is applied to a host device and a digital right management (DRM) server.

### DETAILED DESCRIPTION OF THE INVENTION

Hereinafter, an exemplary embodiment of the present invention will be described in detail with reference to the accompanying drawings. It should be noted that like reference numerals refer to like elements illustrated in one or more of the drawings. In the following description of the present invention, detailed description of known functions and configurations incorporated herein will be omitted for conciseness and clarity.

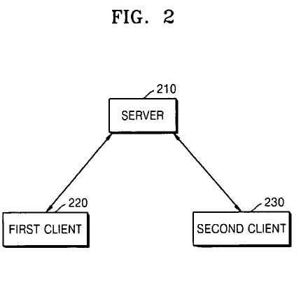

FIG. 2 is a view for explaining an environment to which an exemplary embodiment of the present invention is applied.

As illustrated in FIG. 2, a server 210 communicates with each of a first client 220 and a second client 230. To this end, the server 210 authenticates each of the first client 220 and the second client 230. Completion of authentication between the server 210 and the first client 220 means generation of a session key shared only between the server 210 and the first client 220. Likewise, completion of authentication between the server 210 and the second client 230 means generation of a session key shared only between the server 210 and the second client 230.

The present invention suggests a method and apparatus for performing authentication between the first client 220 and the second client 230 in this environment. The first client 220 and the second client 230 perform authentication using existing session keys without performing encryption and decryption using private keys or public keys as seen in the related art. In other words, according to an exemplary embodiment of the present invention, each of the first client 220 and the second client 230 authenticates the other using its own session key shared with the server 210. During the authentication process, a hash function is used. The hash function is an irreversible function in which the original input value cannot be obtained from a hash value and the same hash value is output for the same input value. Various hash functions can be used, and thus the hash function is not limited to a particular one in the exemplary embodiment of present invention.

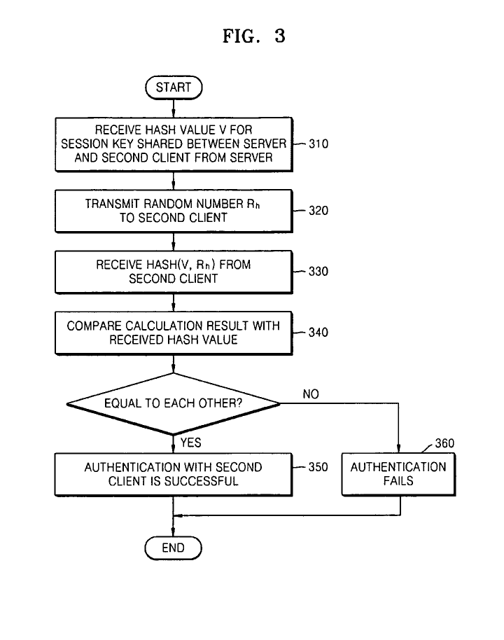

FIG. 3 is a flowchart of a process in which the first client 220 authenticates the second client 230 according to an exemplary embodiment of the present invention.

In operation 310, the first client 220 receives a hash value V for a session key shared between the server 210 and the second client 230 from the server 210.

In operation 320, the first client 220 generates a random number Rₕ and transmits the generated random number Rₕ to the second client 230.

In operation 330, the first client 220 receives Hash(V, Rₕ) from the second client 230. Hash(V, Rₕ) indicates a hash value with respect to V and Rₕ. A hash function used at this time may be different from that used to generate the hash value v using the session key shared between the server 210 and the second client 230.

In operation 340, the first client 220 calculates Hash(V, Rₕ) and compares the calculation result with the hash value received in operation 330. A hash function used at this time has to be the same as that used for the second client 230 to generate the hash value with respect to V and Rₕ, i.e., data transmitted to the first client 220 in operation 330.

If the received hash value is equal to the calculation result of Hash(V, Rₕ) in operation 340, the first client 220 determines that authentication is successful and thus trusts the second client 230 as a communication partner in operation 350. Since V is a session key shared between the second client 230 and the server 210 and Rₕ is information generated by the first client 220 at random and transmitted to the second client 230, only the second client 230 can generate Hash(V, Rₕ).

If the received hash value is not equal to the calculation result of Hash(V, Rₕ) in operation 340, the first client 220 determines that authentication fails in operation 360.

Although authentication information for authentication is derived from a session key using a hash function in the current exemplary embodiment of the present invention, any algorithm capable of irreversibly generating a unique output value with respect to a particular input value, without being limited to the hash function, can also be used in an exemplary embodiment of the present invention.

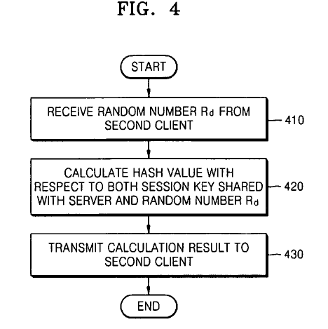

FIG. 4 is a flowchart of a process in which the first client 220 transmits authentication information to the second client 230 according to an exemplary embodiment of the present invention.

In FIG. 3, the first client 220 authenticates the second client 230 using authentication information received from the second client 220. In FIG. 4, the first client 220 transmits the authentication information to the second client 230 in order to allow the second client 230 to authenticate the first client 220.

In operation 410, the first client 220 receives a random number R_{d} from the second client 230. The random number R_{d} is selected by the second client 230 at random.

In operation 420, the first client 220 calculates a hash value with respect to both a hash value with respect to a session key shared between the first client 220 and the server 210 and the random number R_{d}.

In operation 430, the first client 220 transmits the calculated hash value to the second client 230.

Since only the first client 220 can generate the hash value using the hash value with respect to the session key shared between the first client 220 and the server 210 and the random number R_{d} selected by the second client 230 at random, the second client 230 can trust the first client 220 using received data.

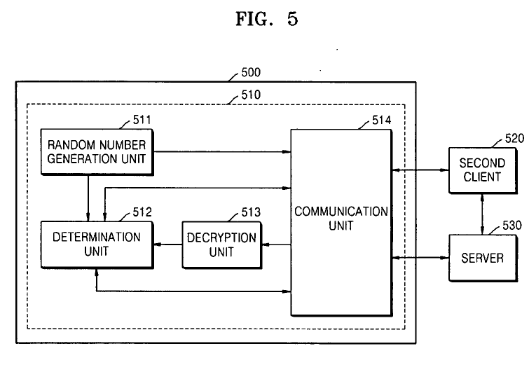

FIG. 5 is a block diagram of an apparatus 510 for performing authentication using a session key according to an exemplary embodiment of the present invention.

The apparatus 510 is included in a first client 500 in order to perform authentication with a second client 520 using a session key shared with a server 530.

Referring to FIG. 5, the apparatus 510 includes a random number generation unit 511, a determination unit 512, a decryption unit 513, and a communication unit 514.

Hereinafter, operations of components of the apparatus 510 during a first process in which the first client 500 verifies the identity of the second client 520 will be described and then operations of the components during a second process in which the first client 500 transmits authentication information to the second client 520 in order to allow the second client 520 to authenticate the first client 500 will be described.

First, the operations of the components of the apparatus 510 during the first process will be described.

The server 530 transmits a first hash value with respect to a session key shared between the second client 520 and the server 530 to the first client 500. Preferably, the first hash value is transmitted after being encrypted using a session key shared between the first client 500 and the server 530. Encrypted data is decrypted by the decryption unit 513 and then is delivered to the determination unit 512.

The random number generation unit 511 generates a random number and transmits the generated random number to the communication unit 514 and the determination unit 512. The communication unit 514 transmits the received random number to the second client 520. The second client 520 inputs a hash value with respect to its session key shared with the server 530 and the received random number to a hash function, thereby calculating a second hash value. The communication unit 514 receives the second hash value and transmits the received second hash value to the determination unit 512.

The determination unit 512 inputs the random number generated by the random number generation unit 511 and the first hash value decrypted by the decryption unit 513 to a hash function, thereby calculating a third hash value. The determination unit 512 also compares the third hash value with the second hash value received from the communication unit 514. If the two hash values are equal to each other, the determination unit 512 determines that authentication is successful and trusts subsequent messages received from the second client 520. If the two hash values are not equal to each other, the determination unit 512 determines that authentication fails.

Next, the operations of the components of the apparatus 510 during the second process in which the first client 500 transmits authentication information to the second client 520 in order to allow the second client 520 to authenticate the first client 510 will be described.

The communication unit 514 receives a random number from the second client 520 and transmits the received random number to the determination unit 512. The determination unit 512 inputs a hash value with respect to a session key shared between the first client 500 and the server 530 and the received random number to a hash function, thereby calculating a fourth hash value.

The communication unit 514 transmits the calculated fourth hash value to the second client 520. The second client 520 then can verify the identity of the first client 500 using the received fourth hash value.

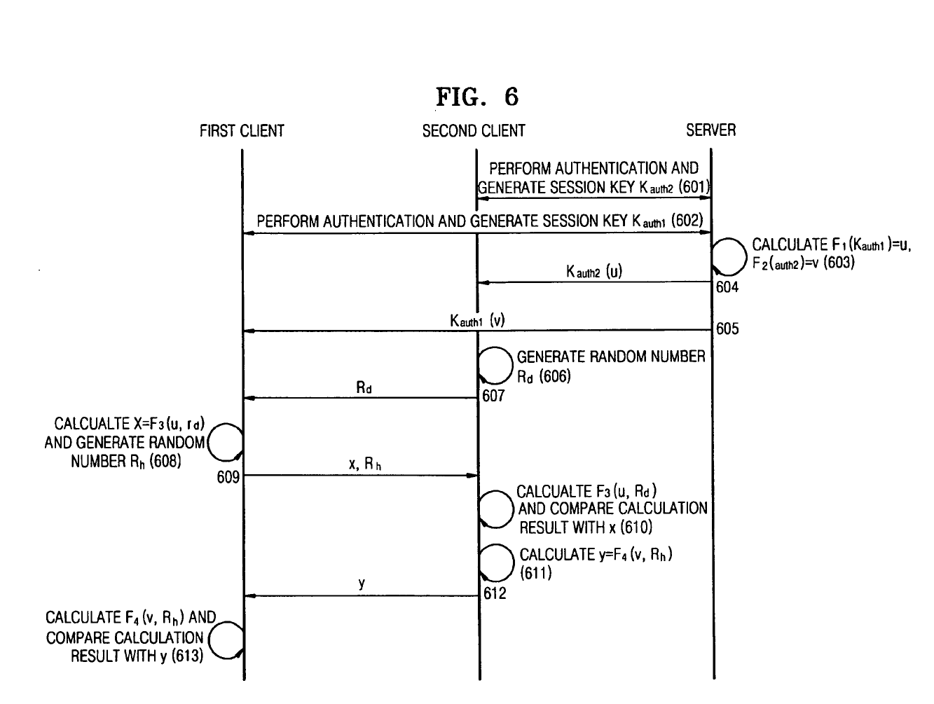

FIG. 6 is a view for explaining a method of performing authentication using a session key according to an exemplary embodiment of the present invention.

In operations 601 and 602, each of the first client and the second client performs authentication with the server, thereby sharing a session key with the server 530. Let a session key shared between the first client and the server be Kₐᵤₜₕ₁ and a session key shared between the second client and the server be Kₐᵤₜₕ₂.

In operation 603, the server calculates f₁(Kₐᵤₜₕ₁)=u and f₂(Kₐᵤₜₕ₂)=v. In the following description, f indicates a hash function and hash functions f having different subscripts, such as f₁ and f₂, imply that different hash functions may be used.

In operation 604, the server encrypts u with Kₐᵤₜₕ₂ and transmits the encrypted u to the second client.

In operation 605, the server encrypts v with Kₐᵤₜₕ₁ and transmits the encrypted v to the first client.

In operation 606, the second client generates a random number rd.

In operation 607, the second client transmits the generated random number R_{d} to the first client 500.

In operation 608, the first client calculates x=f₃(u, R_{d}) using the received R_{d} and u. The first client can calculate u because it already has Kₐᵤₜₕ₁. The first client 500 also generates a random number Rₕ.

In operation 609, the first client transmits x and Rₕ to the second client 520.

In operation 610, the second client calculates f₃(u, R_{d}) and compares the calculation result with x. Although u is a hash value with respect to Kₐᵤₜₕ₁, it can also be obtained by decrypting encrypted data received in operation 604. If the calculation result and x are equal to each other, it is determined that authentication with the first client is successful. On the other hand, if the calculation result and x are not equal to each other, it is determined that authentication with the first client 500 fails.

In operation 611, the second client calculates y=f₄(v, Rₕ).

In operation 612, the second client transmits y to the first client.

In operation 613, the first client calculates f₄(v, Rₕ) and compares the calculation result with y. Although v is a hash value with respect to Kₐᵤₜₕ₂, it can also be obtained by decrypting encrypted data received in operation 605. If the calculation result and y are equal to each other, it is determined that authentication with the second client is successful. On the other hand, if the calculation result and y are not equal to each other, it is determined that authentication with the second client fails.

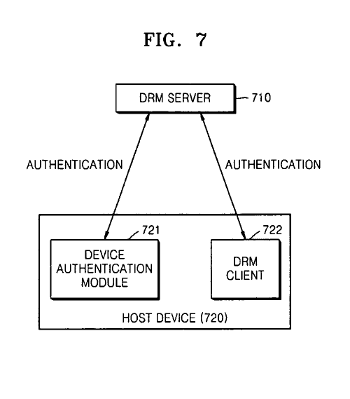

FIG. 7 is a view for explaining a case where an exemplary embodiment of the present invention is applied to a host device 720 and a digital right management (DRM) server 710.

The present invention can be efficiently used in an environment as illustrated in FIG. 7. The host device 720 can use contents provided from the DRM server 710 by performing authentication with the DRM server 710. Such an authentication procedure is performed by a device authentication module 721 of the host device 720. Generally, the host device 720 may be a set top box, a personal digital assistant (PDA), or a cellular phone, and the device authentication module 721 may be implemented with hardware, software, or firmware.

Once a DRM client 722 is installed in the host device 720, it decrypts content, protects a secret key, and reports the DRM server 710 of record associated with user's content consumption. The DRM client 722 also performs authentication with the DRM server 710.

The host device 720 needs to verify whether the DRM client 722 is tampered, i.e., the DRM client 722 is granted authority from the DRM server 710. The DRM client 722 also needs to verify whether the host device 720 is authorized to use a service of the DRM server 710.

Thus, in this case, the device authentication module 721 of the host device 720 and the DRM client 722 can rapidly and efficiently perform authentication with each other using their own session keys shared with the DRM server 710 according to an exemplary embodiment of the present invention.

Meanwhile, the present invention can be exemplarily embodied as a program that can be implemented on computers and can be implemented on general-purpose digital computers executing the program using computer-readable recording media.

Examples of the computer-readable recording media include magnetic storage media such as read-only memory (ROM), floppy disks, and hard disks, and optical data storage devices such as CD-ROMs and digital versatile discs (DVD).

As described above, according to exemplary embodiments of the present invention, encryption and decryption using private keys or public keys are required during authentication between two entities, thereby reducing the time and resources required for the authentication.

While the present invention has been particularly shown and described with reference to an exemplary embodiment thereof, it will be understood by those of ordinary skill in the art that various changes in form and detail may be made therein without departing from the spirit and scope of the present invention as defined by the following claims.

What is claimed is:

1. A method of performing authentication in which a first client sharing a first session key with a server performs authentication with a second client sharing a second session key with the server, the method comprising:
receiving first authentication information generated using the second session key from the server;
receiving second authentication information generated using the second session key from the second client; and
determining whether the authentication with the second client is successful using the first authentication information and the second authentication information.

2. The method of claim 1, further comprising generating a first random number and transmitting the generated first random number to the second client,
wherein the first authentication information is a first hash value with respect to the second session key and the second authentication information is a second hash value with respect to both the first random number and the first authentication information.

3. The method of claim 2, wherein the determining comprises:
calculating a third hash value with respect to both the first random number and the first authentication information;
comparing the calculated third hash value with the received second authentication information; and
determining that the authentication with the second client is successful if the calculated third hash value is equal to the received second authentication information.

4. The method of claim 2, further comprising:
receiving a second random number generated by the second client from the second client;
generating third authentication information that is a fourth hash value with respect to both the received second random number and the second hash value with respect to the first session key; and
transmitting the generated third authentication information to the second client.

5. The method of claim 2, wherein the receiving the first authentication information comprises:
receiving data obtained by encrypting the first authentication information with the first session key; and
decrypting the received data.

6. The method of claim 1, wherein the server is a digital right management (DRM) server, the first client is a DRM client, and the second client is a host device in which the DRM client is installed.

7. A computer-readable recording medium having recorded thereon a program for executing a method of performing authentication in which a first client sharing a first session key with a server performs authentication with a second client sharing a second session key with the server, the method comprising:
receiving first authentication information generated using the second session key from the server;
receiving second authentication information generated using the second session key from the second client; and
determining whether the authentication with the second client is successful using the first authentication information and the second authentication information.

8. An apparatus for performing authentication, the apparatus comprising:
a communication unit which receives first authentication information generated using a second session key from a server and receives second authentication information generated using the second session key from a second client; and
a determination unit which determines whether the authentication with the second client is successful using the first authentication information and the second authentication information.

9. The apparatus of claim 8, further comprising a random number generation unit which generates a first random number,
wherein the communication unit transmits the generated first random number to the second client.

10. The apparatus of claim 9, wherein the first authentication information is a first hash value with respect to the second session key and the second authentication information is a second hash value with respect to both the first random number and the first authentication information, and
the determination unit calculates a third hash value with respect to both the first random number and the first authentication information, compares the calculated third hash value with the received second authentication information, and determines that the authentication with the second client is successful if the calculated third hash value is equal to the received second authentication information.

11. The apparatus of claim 10, wherein the communication unit receives a second random number generated by the second client from the second client and transmits third authentication information that is a fourth hash value with respect to both the received second random number and the second hash value with respect to the first session key to the second client, and the determination unit generates the third authentication information.

12. The apparatus of claim 8, further comprising a decryption unit which decrypts data encrypted with the first session key, wherein the communication unit receives the first authentication information in a state encrypted with the first session key.

13. The apparatus of claim 8, wherein the server is a digital right management (DRM) server, the first client is a DRM client, and the second client is a host device in which the DRM client is installed.
